(19) United States
(12) Patent Application Publication
(10) Pub. No.: US 2009/0199244 A1
(43) Pub. Date: Aug. 6, 2009

(54) Method for mobile acquisition of digital terrestrial television programs in the presence of multiple transmission areas

(76) Inventors: Thomas James Woch, Los Altos, CA (US); Paul Dennis Hewitt, Exeter (GB); Bernal Antonio Arroyo, San Jose, CA (US); Eric Andrew Dorsey, Palo Alto, CA (US)

Correspondence Address: Thomson Licensing LLC, P.O. Box 5312, Two Independence Way, PRINCETON, NJ, 08543-5312, US

(21) Appl. No.: 11/990,806

(22) PCT Filed: Aug. 23, 2006
(86) PCT No.: PCT/US2006/032711

§ 371 Date: Feb. 21, 2008

Related U.S. Application Data
(60) Provisional application No. 60/710,839, filed on Aug. 24, 2005.

(51) Int. Cl. H04N 7/16

(52) U.S. Cl. 725/62

(57) ABSTRACT

The mobile acquisition of digital terrestrial television programs in the presence of multiple transmission areas is performed by using a combination of static topology information and dynamic information within the digital stream. Static topology of the transmission cells in a particular geographic area is used to identify potential adjacent transmission cells offering the same digital terrestrial broadcast (DTB) services. Dynamic PSI information as to a particularly frequency in an identified adjacent transmission cell is acquired and used to provide seamless transition of the DTB services to the mobile video device as they move from one transmission cell to another.

### BACKGROUND

1. Field of the Invention

The present invention relates to terrestrial Television networks. More particularly, it relates to the mobile acquisition of digital terrestrial television programs in the presence of multiple transmission areas.

2. Description of the Prior Art

Terrestrial television (also known as over-the-air, OTA or broadcast television) was the traditional method of television broadcast signal delivery prior to the advent of cable and satellite television. Although still in wide use, in some countries it is slowly becoming obsolete but in others, digital terrestrial has become popular. It works via radio waves transmitted through open space, usually unencrypted (commonly known as “free-to-air” television).

Terrestrial television broadcasting dates back to the very beginnings of television as a medium itself with the first long-distance public television broadcast from Washington, D.C., on Apr. 7, 1927. Aside from transmission by high-flying planes moving in a loop using a system developed by Westinghouse called Stratovision, there was virtually no other method of television delivery until the 1950s with the advent of cable television, or community antenna television (CATV). The first non-terrestrial method of delivering television signals that in no way depended on a signal originating from a traditional terrestrial source began with the use of communications satellites during the 1960s and 1970s.

In the United States and most of the rest of North America as well, terrestrial television underwent a revolutionary transformation with the eventual acceptance of the NTSC standard for color television broadcasts in 1953. Later, Europe and the rest of the world either chose between the later PAL and SECAM color television standards, or adopted NTSC.

In addition to the threat from CATV, analog terrestrial television is now also subject to competition from satellite television and distribution of video and film content over the Internet. The technology of digital terrestrial television has been developed as a response to these challenges. The rise of digital terrestrial television, especially HDTV, may mark an end to the decline of broadcast television reception via traditional receiving antennas, which can receive over-the-air HDTV signals.

In North America, terrestrial broadcast television operates on TV channels 2 through 6 (VHF-low band, known as band I in Europe), 7 through 13 (VHF-high band, known as band III elsewhere), and 14 through 69 (UHF television band, elsewhere bands IV and V). Channel numbers represent actual frequencies used to broadcast the television signal. Additionally, television translators and boosters can be used to rebroadcast a terrestrial TV signal using an otherwise unused channel to cover areas with marginal reception.

In Europe, a planning conference (“ST61”) held under the auspices of the International Telecommunications Union in Stockholm in 1961 allocated frequencies the Bands IV and V for the first time for broadcast television use. It also superseded the 1951 Plan (also made in Stockholm) which had first allocated Band II frequencies for FM radio and Band III frequencies for television.

Following the ST61 conference, UHF frequencies were first used in the UK in 1964 with the introduction of BBC2. Television broadcasting in Band III continued after the introduction of four analogue programmes in the UHF bands until the last VHF transmitters were switched off on Jan. 6, 1985.

The success of terrestrial analogue television across Europe varies from country to country. Although each country has rights to a certain number of frequencies by virtue of the ST61 plan, not all of them have been bought into service.

By the mid 1990s, the interest in digital television across Europe was such the CEPT convened the “Chester '97” conference to agree means by which digital television could be inserted into the ST61 frequency plan.

The introduction of digital television in the late 1990s and early years of the 21st century led the ITU to call a Regional Radio Communications Conference to abrogate the ST61 plan and to put a new plan for digital broadcasting only in its place.

By the year 2012, the EU will be entirely switched to digital terrestrial television broadcasting. Some EU member states have decided to complete this switchover as early as 2008 (e.g. Sweden).

These digital terrestrial television broadcasting networks are multi-frequency networks (MFN). In this configuration, each given service is transmitted at a different frequency throughout the coverage area. Within each multiplex there are normally 8-12 services. Examples of services in the UK are BBC One, ITV1, Sky Travel and BBC Radio 1.

With this new age of digital terrestrial television networks, mobile television devices will not only become more popular, they will inherently require additional capabilities to provide the seamless flow of information to the end user without drop out or other interference that may be caused by traveling through multiple transmission areas.

### SUMMARY OF THE INVENTION

Digital Video Broadcasting (DVB) compliant terrestrial TV networks carry service information (SI) within the digital signal describing the television programming available on the transmission network. Neighboring transmission networks may carry similar programming. The present principles provide a method for quickly identifying existing services in new networks, while traveling among cells, using a combination of static topology information and dynamic information within the digital stream, thus enabling a mobile video receiver to travel among various cells while continuing to play the same program

This and other aspects of the present principles are achieved by identifying movement of a mobile device from an initial transmission cell into another transmission cell, identifying each transmission cell that is adjacent the initial transmission cell using a static topology database of transmission cells, conducting a dynamic program service information (PSI) inquiry into at least one of the identified adjacent transmission cells, acquiring the dynamic PSI information from the identified adjacent transmission cell when data is found during the PSI inquiry, and providing the DTB service to the mobile device from the adjacent transmission cell.

In accordance with one implementation, the conducting the PSI inquiry further includes determining whether the DTB Service is available on a frequency in an identified adjacent transmission cell, and determining that the frequency in the identified adjacent transmission cell contains data corresponding to the DTB service. When no data is contained on the identified frequency, another adjacent transmission cell attempted.

In accordance with another implementation, the conducting of the PSI inquiry further includes determining whether the DTB Service is available on a frequency in an identified adjacent transmission cell, and performing a traditional SI Scan on the adjacent transmission cell when it is determined that the DTB service is not available on a frequency in the adjacent transmission cell.

In one implementation, the providing of the DTB service includes determining whether the DTB service is playing in the adjacent transmission area, and determining data channel PIDS to provide the service in the adjacent transmission area when the DTB Service is provided. When it is determined that the DTB service is not playing in the adjacent transmission area, another adjacent transmission cell is attempted.

The DTB service can be, for example television, pay television, interactive programming, and/or radio.

According to yet a further implementation of the present principles, the method for mobile acquisition of digital terrestrial television programs in the presence of multiple transmission cells includes, identifying that a program being viewed by a mobile video device can no longer be played from an initial transmission cell, identifying at least one transmission cell adjacent the initial transmission cell using a static topology map of transmission cells, determining whether the program is available on a frequency in an identified adjacent transmission cell, acquiring dynamic PSI information for the identified adjacent transmission cell when the program is available on a frequency in the identified adjacent transmission cell, determining whether the program is playing in the adjacent transmission cell, and playing the program at the mobile device from the adjacent transmission cell when the program is playing in the adjacent transmission cell.

The identification of at least one transmission cell further includes consulting a static topological transmission area database for transmissions cells adjacent the initial transmission cell. In addition, the determination as to whether the program is available on a frequency in the identified adjacent transmission cell further includes probing the frequency for data when it is determined that the program is available on the frequency. When there is no program available on that frequency of the adjacent transmission cell, a traditional SI scan is performed.

In yet further implementations, the method for mobile acquisition of digital terrestrial broadcast (DTB) services in the presence of multiple transmission cells includes determining that a service being provided to a mobile device in a first transmission cell is being lost by movement of the mobile device out of the first transmission cell, identifying transmission cells adjacent the first transmission cell, determining whether the service being provided previously in the first transmission cell is available on a frequency in the identified adjacent transmission cell, acquiring dynamic PSI information for the identified adjacent transmission cell when data is present on the frequency, and providing the service at the mobile device from the adjacent transmission cell when it is determined that the service is being provided by the adjacent transmission cell.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a diagrammatic representation of the United Kingdom showing an exemplary transmitter coverage map for a digital terrestrial television network in which the present principles may be implemented; and

FIG. 2 is a flow diagram of the mobile acquisition of digital terrestrial television programs in the presence of multiple transmission areas, according to an aspect of the present principles.

### DETAILED DESCRIPTION

It is to be understood that the present principles may be implemented in various forms of hardware, software, firmware, special purpose processors, or a combination thereof. Preferably, the present principals are implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present principles is programmed. Given the teachings herein, one of ordinary skill in the related art will be able to contemplate these and similar implementations or configurations of the present principles.

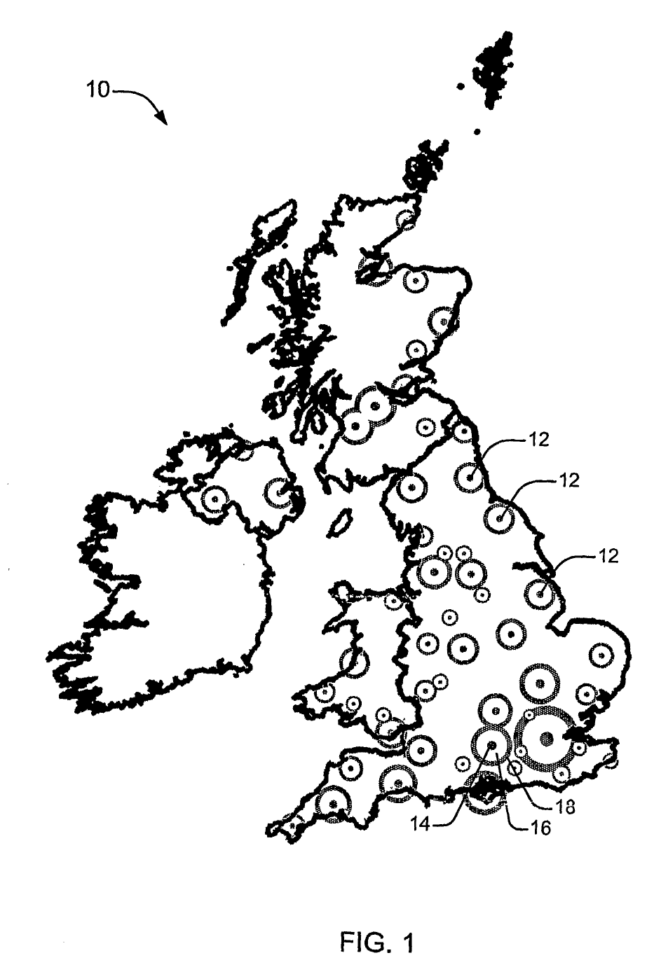

FIG. 1 shows a geographic map 10 of the United Kingdom (UK). The use of the geographic region of the UK is shown here for exemplary purposes only. Those of skill in the art will recognize that the concepts and principles disclosed herein can be applied to any digital terrestrial network in any geographic area without departing from the spirit of the same. Generally speaking, the country or geographic area is covered by a plurality of transmitters 12, and the transmitters 12 are dispersed throughout the geographic area such that the coverage area of some overlap, while others do not. The topological map of FIG. 1 can be stored as a static topological cell database that can be used as reference when transitioning from one transmission area to another.

By way of example, each transmitter 12 has as particular power rating and as such have different coverage areas. As would be expected, the signal reception area is strongest at the center 14, and dissipates concentrically from the transmitter so as to form two other regions 16 and 18, where the strength of the particular transmitter's signals is weaker and requires additional antenna strength. In the UK example provided herein, each transmitter 12 includes 6 multiplexes (1, 2, A, B, C and D). Each multiplex is transmitted at a different frequency from the other 5 multiplexes on the same transmitter and from adjacent transmitters. Each multiplex carries 8-12 services (e.g., TV, radio, and interactive services).

Thus, when a mobile video device moves toward the outer regions of a particular transmission cell/area (i.e., the weaker signal strength portions of the particular transmission cell/area), the mobile TV or other video device must be capable of identifying the changing frequencies in adjacent transmitter sites for the same channel, so as to avoid signal drop out or other interference that may be caused by traveling through multiple transmission areas. The method of the present principles addresses and resolves this potential problem with mobile acquisition of digital terrestrial TV programs in the presence of multiple transmission areas.

Digital Video Broadcasting Terrestrial (DVB-T) compliant digital television transmission signals contain service information (SI) that maps programming and content to frequencies within the physical transmission region or network. Tuning to various frequencies and extracting digital channel information (called PIDS) allows audio and video for television programs to be displayed on a television or other video device (e.g., mobile video devices).

Programs are identified by the service ID. Thus, knowing the service ID not only allows the SI tables (or maps) to be navigated, but also enables the identification of the frequency on which the service is played and the digital channel information to be determined, so that the program can be decoded and displayed.

In the presence of multiple transmission cells (areas), as is the case with mobile video devices, a particular program may be found on different frequencies with different digital channel information in the different transmission cells. Using a combination of static topological information and dynamic SI information within the stream, the method and system of the present principles enables a quick determination of the required information to play the program when transitioning from one cell to the next.

In order to achieve this, the service information embedded in the digital stream is divided into two types: 1) Quasi-Static Network and Service information, and 2) dynamic program service information (PSI). The Quasi-Static Network and Service information describes the transmission network and service-to-frequency mapping. The dynamic PSI describes digital channel information in order to play the programming. Since the first type of information is relatively static (i.e., geographical information about the respective transmitting cells), a topological map of all transmission cells or areas within the target television market can be compiled. This map describes all of the transmission cells, the services they provide, the frequencies they transmit and, most importantly, how they overlap.

When transitioning from one transmission cell to the next, the topological map can be used to probe all of the transmission cells (e.g., scan the airwaves) that overlap with the current one to quickly determine which cell the device will be moving into. This allows the device to determine on what frequency, in the new transmission cell, that the program may be found. Once the frequency is known, the dynamic PSI information can be quickly probed to determine the digital channel information for the program. At this point the program can now be played in the new transmission cell.

The method of the present principles, as herein described, reduces the time required for a mobile device to acquire and play a program or provide the continuing service in the new transmission cell by nearly an order of magnitude (i.e., 2-3 seconds as opposed to 20-30 seconds).

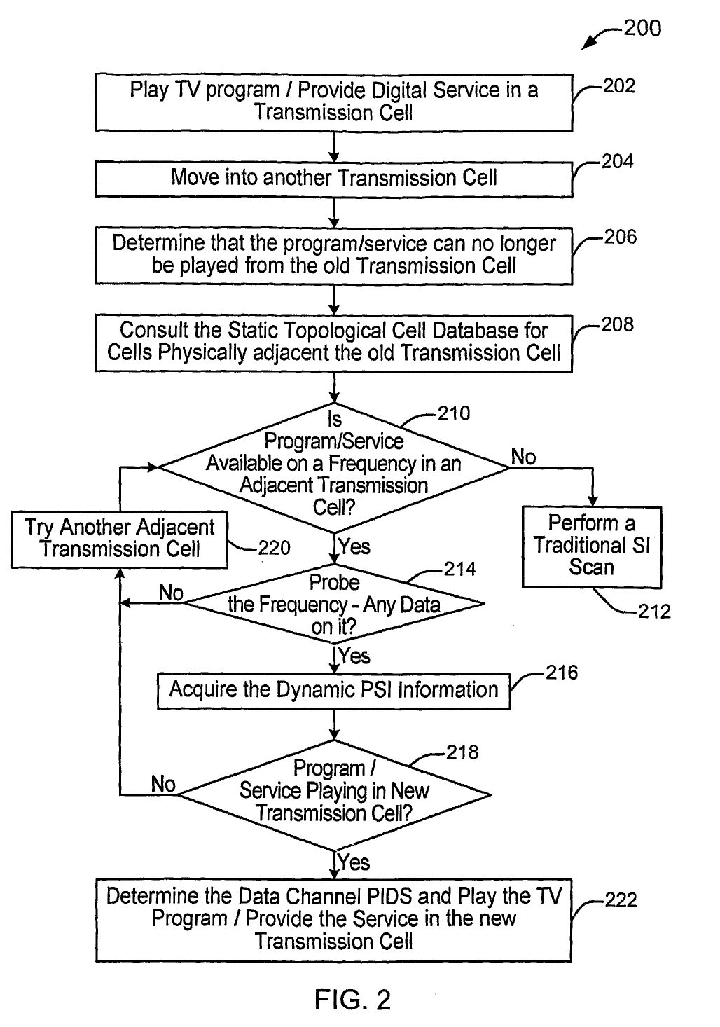

FIG. 2 shows a flow chart 200 of an exemplary implementation of the method for mobile acquisition of digital terrestrial television programming or other broadcast services, according to an aspect of the present principles. As used herein, digital terrestrial broadcast (DTB) services includes, for example, (DVB-T) compliant digital television programming, other types of digital television programming, pay television programming, data services, radio services and interactive video programs and systems.

In the exemplary embodiment shown, the user selects to play a TV program in a first transmission cell (202). The user then moves into the area of another transmission cell (204). The mobile TV device then determines that the TV program can no longer be played from the previous (old) transmission cell (206). The system then consults a static topological cell database for transmission cells that are physically adjacent to the previous (old) transmission cell (208). The system then determines (210) if the TV program is available on a frequency in an adjacent cell. If “no”, a traditional SI scan (212) is performed. [What happens after this scan?] If “yes”, the frequency is probed (214) to determine if there is any data on it (i.e., is the programming there?). If the is no data on the frequency, another adjacent cell is tried (220), and the determination of whether the program is available on a frequency in the adjacent cell (210) is performed again.

When there is data on the probed frequency (214), the dynamic PSI information for that frequency is acquired (216) and a determination is made whether the service is being provided in the new cell (transmission area) (218). If it is, the data channel PIDS are determined to play the TV program or provide the service in the new cell (transmission area) (222). If the service is not playing in the new cell, another adjacent cell (transmission area) is attempted (220) and the process repeated.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

1. A method for mobile acquisition of digital terrestrial broadcast (DTB) services in the presence of multiple transmission cells, the method comprising the steps of:
identifying movement of a mobile device from an initial transmission cell into another transmission cell;
identifying each transmission cell that is adjacent the initial transmission cell using a static topology database of transmission cells;
conducting a dynamic program service information (PSI) inquiry into at least one of the identified adjacent transmission cells;
acquiring the dynamic PSI information from the identified adjacent transmission cell when data is found during the PSI inquiry; and
providing the DTB service to the mobile device from the adjacent transmission cell.

2. The method of claim 1, wherein said conducting further comprises:
determining whether the DTB Service is available on a frequency in an identified adjacent transmission cell; and
determining that the frequency in the identified adjacent transmission cell contains data corresponding to the DTB service.

3. The method of claim 2, further comprising trying another adjacent transmission cell when it is determined that no data is contained on the identified frequency.

4. The method of claim 1, wherein said conducting further comprises:
determining whether the DTB Service is available on a frequency in an identified adjacent transmission cell; and
performing a traditional SI Scan on the adjacent transmission cell when it is determined that the DTB service is not available on a frequency in the adjacent transmission cell.

5. The method of claim 1, wherein said providing further comprises:
determining whether the DTB service is playing in the adjacent transmission area; and
determining data channel PIDS to provide the service in the adjacent transmission area when the DTB Service is provided.

6. The method of claim 5, further comprising trying another adjacent transmission cell when it is determined that the DTB service is not playing in the adjacent transmission area.

7. The method of claim 1, wherein the DTB service comprises at least one selected from a group consisting of television, pay television, interactive programming, and radio.

8. A method for mobile acquisition of digital terrestrial television programs in the presence of multiple transmission cells, the method comprising:
identifying that a program being viewed by a mobile video device can no longer be played from an initial transmission cell;
identifying at least one transmission cell adjacent the initial transmission cell using a static topology map of transmission cells;
determining whether the program is available on a frequency in an identified adjacent transmission cell;
acquiring dynamic PSI information for the identified adjacent transmission cell when the program is available on a frequency in the identified adjacent transmission cell;
determining whether the program is playing in the adjacent transmission cell; and
playing the program at the mobile device from the adjacent transmission cell when the program is playing in the adjacent transmission cell.

9. The method of claim 8, wherein said identifying at least one transmission cell further comprises consulting a static topological transmission area database for transmissions cells adjacent the initial transmission cell.

10. The method of claim 8, wherein said determining whether the program is available on a frequency in the identified adjacent transmission cell further comprises probing the frequency for data when it is determined that the program is available on the frequency.

11. The method of claim 10, further comprising trying another adjacent transmission cell when it is determined that there is no data on the probed frequency.

12. The method of claim 8, further comprising performing a traditional SI scan when there is no program available on a frequency in the adjacent transmission cell.

13. A method for mobile acquisition of digital terrestrial broadcast (DTB) services in the presence of multiple transmission cells, the method comprising:
determining that a service being provided to a mobile device in a first transmission cell is being lost by movement of the mobile device out of the first transmission cell;
identifying transmission cells adjacent the first transmission cell;
determining whether the service being provided previously in the first transmission cell is available on a frequency in the identified adjacent transmission cell;
acquiring dynamic PSI information for the identified adjacent transmission cell when data is present on the frequency; and
providing the service at the mobile device from the adjacent transmission cell when it is determined that the service is being provided by the adjacent transmission cell.

14. The method according to claim 13, wherein said identifying is performed using a static topology map describing all of the transmission cells in a predetermined geographic area, the services they provide, the frequencies they transmit and how they overlap.

15. The method according to claim 13, further comprising trying another adjacent transmission cell when said step of acquiring is not performed due to a lack of data content on the frequency.
